(19) United States
(12) Patent Application Publication
(10) Pub. No.: US 2004/0160062 A1
(43) Pub. Date: Aug. 19, 2004

(54) Mechanical, electro-magnetic device for generating electricity by wind system of horizontal, channelled blades, and additional magnetic input

(76) Inventor: Alejandro Tomas, Barcelona (ES)

Correspondence Address: ALEJANDRO TOMAS, SARDENYA 100 BAJOS, BARCELONA, 08018, ES

(21) Appl. No.: 10/629,576

(22) Filed: Jul. 30, 2003

(30) Foreign Application Priority Data
Feb. 19, 2003 (ES) U200300543

(51) Int. Cl. F03D 9/00; H02P 9/04

(52) U.S. Cl. 290/55

(57) ABSTRACT

1.- Mechanical, electromagnetic device for generating electricity by wind system of horizontal, channelled blades, and additional magnetic input. Characterised by being a system of air-mill for generating electro-mechanical energy with innovative devices such as the horizontal blades (A) and system of additional input of magnetic energy by a magnet engine. (I)-(J)

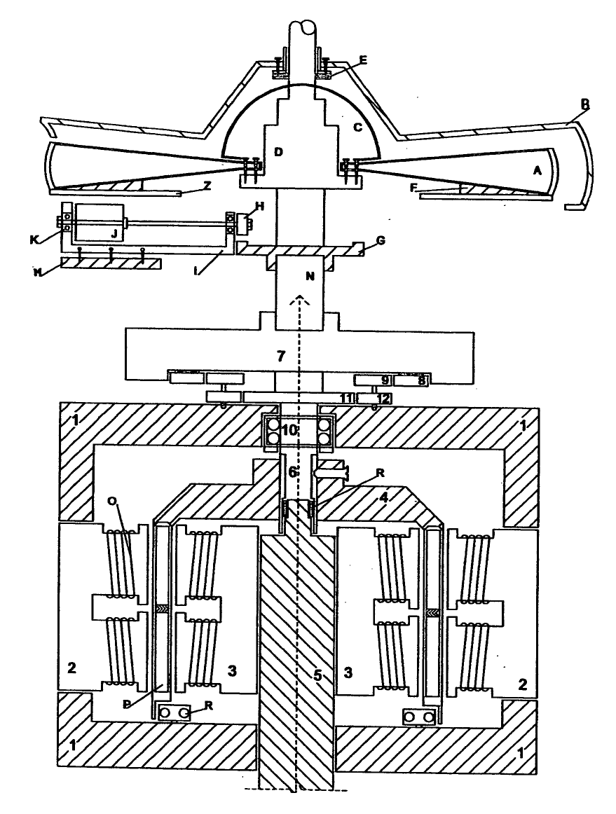

2.- Mechanical, electromagnetic device for generating electricity by wind system of horizontal, channelled blades, and additional magnetic input. Characterised by air capturing system via a floating orientation casing (B) and by regulation of air input flow from 90° to 180° and by the casing (B), with its corresponding mechanical or electronic guidance rudders, being able to orientate itself favourably with respect to the wind.

3.- Mechanical, electromagnetic device for generating electricity by wind system of horizontal, channelled blades, and additional magnetic input. Characterised by having an engine of magnets (F), polar masses coupled to the blades (A) and to the revolving polar mass (J). The said magnet engine contributes considerable energy that greatly increases the maximum performance of the alternator, in comparison to performance without the said magnet engine. The magnets (7) in question can also be housed as an alternative along the main axle (N).

4.- Mechanical, electromagnetic device for generating electricity by wind system of horizontal, channelled blades, and additional magnetic input. Characterised by the fact that the main axle (N) with its extension (6) bears the entire element (4), housed in the alternator incorporating the magnets (P) or electromagnets, according to our choice, or depending on the characteristics of the generator unit to be installed.

The mechanical, electromagnetic wind system the subject of the Utility Model herein, bases itself principally on the fact that its way of working is different from current winds generators, as its design and innovative technological additions completely surpass the systems and methods known at present in the field of conventional wind generators.

The mechanical, electromagnetic device that we describe distinguishes itself from current systems by the fact that the blades capturing and transmitting the wind force work horizontally, instead of the vertical position in which they are used at present.

The design that we describe consists of several technological innovations that, properly combined, achieve a greater performance than current wind generator systems, as they add to the driving force generated by the wind another generation of mechanical forces generated by magnetic systems. If these are correctly employed and combined with turns of the main transmission axle, the total performance of electricity generation is greatly enhanced.

Find Below the Description of the Utility Model Herein.

The system consists of completely innovative elements to those currently known, and which we describe hereinafter, one of the most important being the fact that the blades work horizontally, always in the same direction, given that the system consists of an upper casing in the form of an air channelling-tunnel with an opening for the blades that offers a range in degrees from 90° to a maximum of 180°. The aim of this is to leave the sufficient number of blades exposed in order to derive maximum benefit from the wind force, and at the same time protect the opposite blades so that as far as is possible they do not strike the opposing forces, which could neutralise or detract from performance of the system.

The aim of the casing or channelling-tunnel is to seek the direction of the wind by means of a rudder or side fins (mechanical system) or through an electronic search system with frequency engines or similar (electronic system). This achieves maximum benefit of the wind force in the wind capturing and transmission blades.

In this blades system we must emphasise the description of the following technological innovation, which consists in others that lean on a lower circular base and that, taking advantage of v rtical wind movements, produce exit angles that affect and strike against the wind blades, thus transmitting efforts and movements that are not able to be taken advantage of by windmills or traditional systems.

On the lower base of the windmill-generator where the blades rest there is a set of permanent magnets or electromagnets, that are attracted and repelled by another set of revolving magnets from the base of the central axle via a set of coronas and satellite pinions. These exert a pushing action on the circular, parallel and common base of the blades by attraction and repulsion (polar opposition) in the form of a polar magnet engine. This system provides additional efforts that considerably improve and increase total performance of the wind generator.

Hereinafter, we describe the lower section of the generator or electrical part. Transmission of the main axle in movement will be made use of to install an alternator (without exterior excitation or supply) for generating electrical energy. It comprises the following parts:

Two fixed distinct nuclei without revolving movements, that we call “stator”, one central and the other exterior.

A rotor with circular movement coupled to the transmission axle of the wind blades, in which the permanent magnets or electro-coils are installed, according to need, and that are responsible for creating the required magnetic fields so that together with the stator, electrical energy is created.

We will previously install in the transmission axle a charge alternator, a system of permanent fixed magnets in one of the bases opposed to another revolving casing, also with magnets, that through attraction and repulsion form a magnetic magnet engine, helping to improve mechanical performance and, thus, to obtaining electrical energy.

With reference to the charge alternator (electrical generator), we observe that by having the energy capturing stators with passage of magnetic fields, at a given moment part of the exterior or interior stator itself may be turned into an electrical traction engine. With the resulting increase in pushing or traction force, we will achieve greater energetic performance and, thus, greater electrical energy.

### DESCRIPTION OF THE PARTS OF THE COMPLETE ELEMENT FOR IDENTIFYING THEM IN THE DRAWING

A.—Wind blades; B.—Floating orientation casing; C.—Central Protector; D.—Blade (4A) connecting part; E.—Revolving exterior casing (B) support part; F.—Magnetic polar masses of the blades (A); G.—Main axle (N) central transmission corona; H.—Satellite transmission pinion; I.—Element holding planetary pinion with axle and revolving polar mass (J); J.—Revolving polar mass; K.—Carrier axle bearings; M.—Element (I) support base; N.—Main transmission axle

1.—Element connecting and orientating covers;

2.—Interior fixed nucleus coil holder;

3.—Interior fixed nucleus coil holder

4.—Part bearing the polar masses or revolving electro-coils;

5.—Secondary axle;

6.—Axle (N) extension;

7.—Approximation magnet-holder plate (they act as a magnet engine);

8.—Permanent magnets or electro-magnets;

9.—Revolving magnets;

10.—Main axle (N)—(6) guide bearings;

11. Crown wheel;

Wind-mechanical element

For its correct functioning the previously described electromagnetic wind element comprises the following items:

The wind blades (A) are responsible for capturing the wind force and transmitting mechanical energy through the central axle (N). These blades bear a lower union base (Z) that in turn carries a set of permanent magnets (F).

Channelling of wind force is obtained through the orientation casing (B) as a tunnel with an exposed opening angle for the blades (A) of 90° at minimum and 180° at maximum.

This casing is connected to the revolving part (E) for its free movement over the central and main axle (N). In turn, the blades (A) are fixed or connected to support (D), that also connects the aerodynamic protection casing (C) inside the tunnel of the casing (B).

The main axle (N) carries a circular crown wheel (G) that is responsible for transmitting movement to the satellite pinion (H).

The satellite pinion (H) has a fixed axle installed, at the end of which there is a polar mass (J) fitted, that has the mission of carrying out pushing movements on the fixed magnets (F) or electro-magnets of the circular base (Z). The element comprising the satellite pinion (H), its axle and magnets (J) is fixed so that it can move by bearings (K) on support (I), anchored to support (M) of the tower.

The main axle (N) bears the entire element (7), which has an appropriate battery installed plus an adequate number of permanent magnets (8), whose mission is to be pushed by the revolving magnets (9) via the crown wheel (11), fixed to the main axle (N). This corona moves the trawling pinions (12) whose movement drags the revolving magnets (9), thus facilitating shifting movement of the main axle (N), the revolving magnets (9) remaining attached to the trawling pinions (12) on the connection covers of the element (1).

The element (7) may also be installed in an alternative manner along the main axle (N), as long as the desired amount and number are sufficient to start up the magnet engine that will facilitate circular movement of the main axle (N), thus increasing its force par (engine).

Alternator Unit

In the alternator part we find that extension of the main axle (N) called (6) is bearer of the set of elements (4), being responsible for housing the permanent magnets (P) or electromagnets, according to the option chosen.

These in turn move in revolving fashion among the nuclei or magnets (P), fixed stators (2) and (3), creating a magnetic field sufficient for generating electrical energy.

We note that the stator or coil nucleus (3) stays embedded or fixed in the main axle (5) and that the stator or exterior nucleus (2) is connected on the element union covers (1).

The coils (0) are responsible for electrical generation at their exit or action on their part to create movements as an electrical-mechanical engine.

1.- Mechanical, electro-magnetic device for generating electricity by wind system of horizontal, channelled blades, and additional magnetic input. Characterised by being a system of air-mill for generating electro-mechanical energy with innovative devices such as the horizontal blades (A) and system of additional input of magnetic energy by a magnet engine. (I)-(J)

2.- Mechanical, electromagnetic device for generating electricity by wind system of horizontal, channelled blades, and additional magnetic input. Characterised by an air capturing system via a floating orientation casing (B) and by regulation of air input flow from 90° to 180° and by the casing (B), with its corresponding mechanical or electronic guidance rudders, being able to orientate itself favourably with respect to the wind.

3.- Mechanical, electromagnetic device for generating electricity by wind system of horizontal, channelled blades, and additional magnetic input. Characterised by having an engine of magnets (F), polar masses coupled to the blades (A) and to the revolving polar mass (J). The said magnet engine contributes considerable energy that greatly increases the maximum performance of the alternator, in comparison to performance without the said magnet engine. The magnets (7) in question can also be housed as an alternative along the main axle (N).

4.- Mechanical, electromagnetic device for generating electricity by wind system of horizontal, channelled blades, and additional magnetic input- Characterised by the fact that the main axle (N) with its extension (6) bears the entire element (4), housed in the alternator incorporating the magnets (P) or electromagnets, according to our choice, or depending on the characteristics of the generator unit to be installed.
